(19) United States
(12) Patent Application Publication
(10) Pub. No.: US 2026/0199918 A1
(43) Pub. Date: Jul. 16, 2026

(54) WATER SPRAY GUN

(71) Applicant: ZhongShan QingYi Metal Products Enterprise CO., LTD, ZhongShan City (CN)

(72) Inventors: Weiye Song, ZhongShan City (CN); Kunguang Wu, ZhongShan City (CN); Shulong Li, ZhongShan City (CN); Tang Chieh Yu, Taichung City (TW)

(21) Appl. No.: 19/024,021

(22) Filed: Jan. 16, 2025

(51) Int. Cl. B05B 9/01; B05B 1/30; B05B 12/00

(52) U.S. Cl. CPC B05B 9/01; B05B 1/3066; B05B 12/0022

(57) ABSTRACT

A water spray gun includes a gun body having a handle and a barrel. The handle has a water passage therein. The water passage extends to a front end of the barrel. A valve stem is provided in the barrel and extends out of the barrel. A control lever is pivotally mounted on a rear side of the handle and connected to the valve stem. A positioning buckle is pivotally mounted on a top of the barrel for securing the control lever. A spray head is connected to the front end of the barrel. A front end of the valve stem has a guide hole that is gradually enlarged toward the front end of the valve stem. The valve stem is driven by the control lever to move, thereby changing an area of the guide hole, covered by the spray head, for regulating the flow rate of water.

### FIELD OF THE INVENTION

The present invention relates to a water spray gun, and more particularly, to a water spray gun that is easy to regulate the flow of water.

### BACKGROUND OF THE INVENTION

Water spray guns are often used in gardening, vehicle washing and other work fields that require large-scale water spraying due to their ability to spray water over a large area, enhancing work efficiency.

Conventional water spray guns usually regulate the flow of water by means of rotation. Taiwan Utility Model Publication No. 134737 discloses a water spray gun capable of regulating the flow rate of water. A cavity is formed in the gun body. A hole is formed on a hollow inner tube which is fitted inside the gun body. The hole corresponds to the cavity. By rotating the inner tube to change the position of the hole of the inner tube relative to the cavity, the overlapping area of the hole and the cavity can be changed for controlling the flow rate of water.

However, the position of the inner tube cannot be secured after rotation. In use, it is easy to touch the inner tube by mistake, which will cause the position of the hole of the inner tube relative to the cavity to change and thus can’t control the water flow stably. When in use, it is necessary for the user to grasp the water spray gun with one hand and turn the inner tube with the other hand to regulate the flow of water. It is quite inconvenient for use.

### SUMMARY OF THE INVENTION

The primary object of the present invention is to provide a water spray gun, which is easy to regulate the flow of water and has the advantages of easy application of force, single-handed operation, easy use, simple structure, and low manufacturing cost, while achieving a significant change in the flow rate of water and stabilizing the flow of water.

In order to achieve the foregoing object, the present invention provides a water spray gun, comprising a gun body. The gun body has a handle and a barrel. The handle has a water passage therein. The water passage extends to a front end of the barrel. A valve stem is provided in the barrel and extends out of the barrel. A control lever is pivotally mounted on a rear side of the handle and connected to the valve stem. A positioning buckle is pivotally mounted on a top of the barrel for securing the control lever. A spray head is connected to the front end of the barrel. A front end of the valve stem has a guide hole that is gradually enlarged toward the front end of the valve stem. The valve stem is driven by the control lever to move, thereby changing an area of the guide hole, covered by the spray head, for regulating the flow rate of water.

### BRIEF DESCRIPTION OF THE DRAWINGS

FIG. 1 is a perspective view of the present invention;

FIG. 2 is an exploded view of the present invention;

FIG. 3 is a schematic, cross-sectional view of the present invention in an initial state;

FIG. 4 is a first schematic, cross-sectional view of the present invention in a use state;

FIG. 5 is a second schematic, cross-sectional view of the present invention in a use state;

FIG. 6 is a third schematic, cross-sectional view of the present invention in a use state; and

FIG. 7 is a schematic view of the guide hole in different covered states of the present invention.

### DETAILED DESCRIPTION OF THE PREFERRED EMBODIMENTS

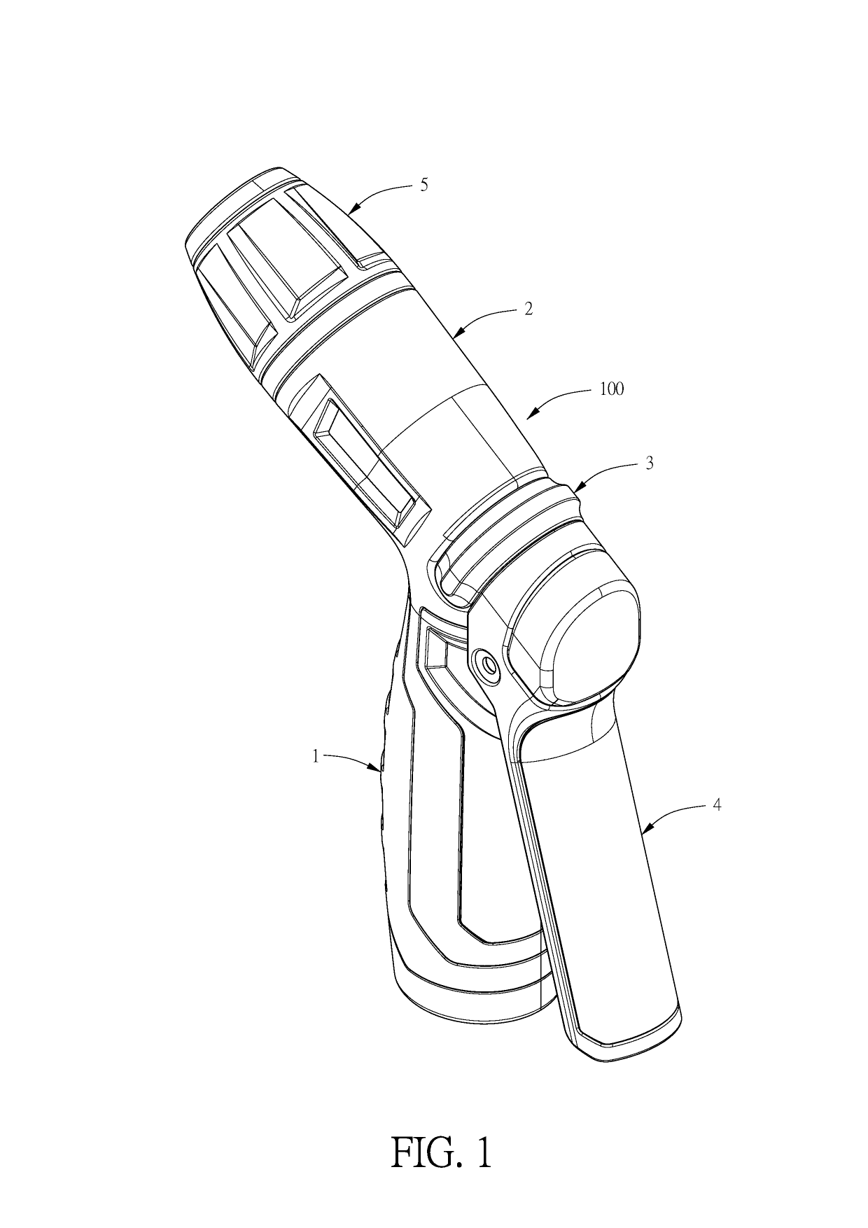

As shown in FIG. 1, the present invention discloses a water spray gun, comprising a gun body 100. The gun body 100 has a handle 1 and a barrel 2 disposed on top of the handle 1. A positioning buckle 3 is pivotally mounted on the top of the barrel 2. A control lever 4 is pivotally mounted on the rear side of the handle 1. The front end of the barrel 2 is connected to a spray head unit 5. The spray head unit 5 includes a spray head 51 and a regulating cap 52. The spray head 51 has a water inlet end 511 inserted and screwed into the front end of the barrel 2 and a water outlet end 512 screwed to the regulating cap 52.

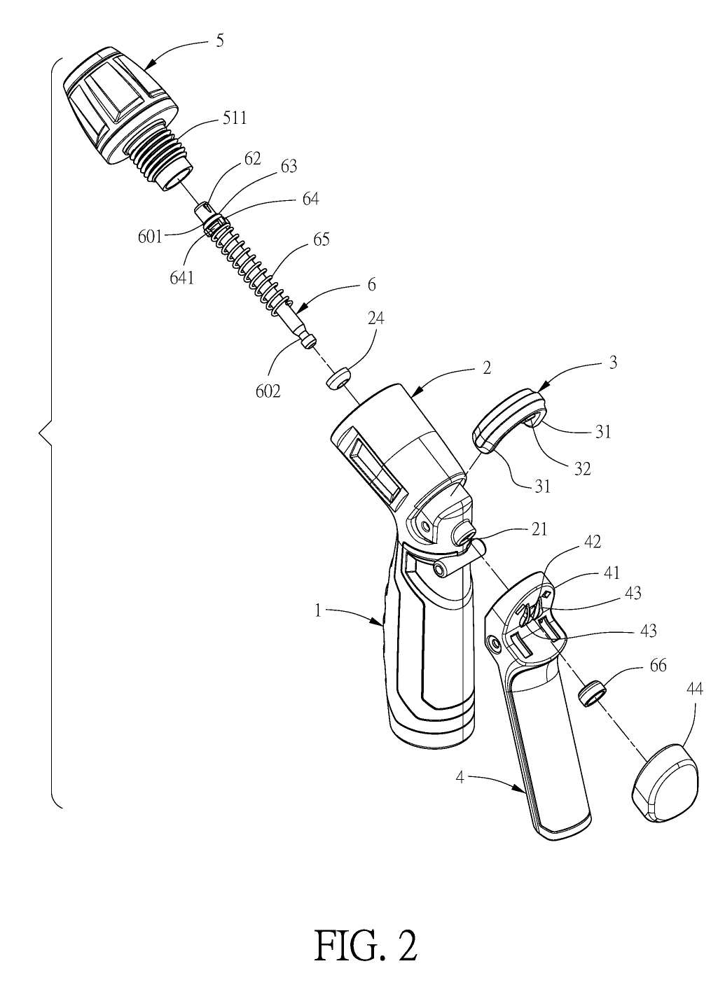

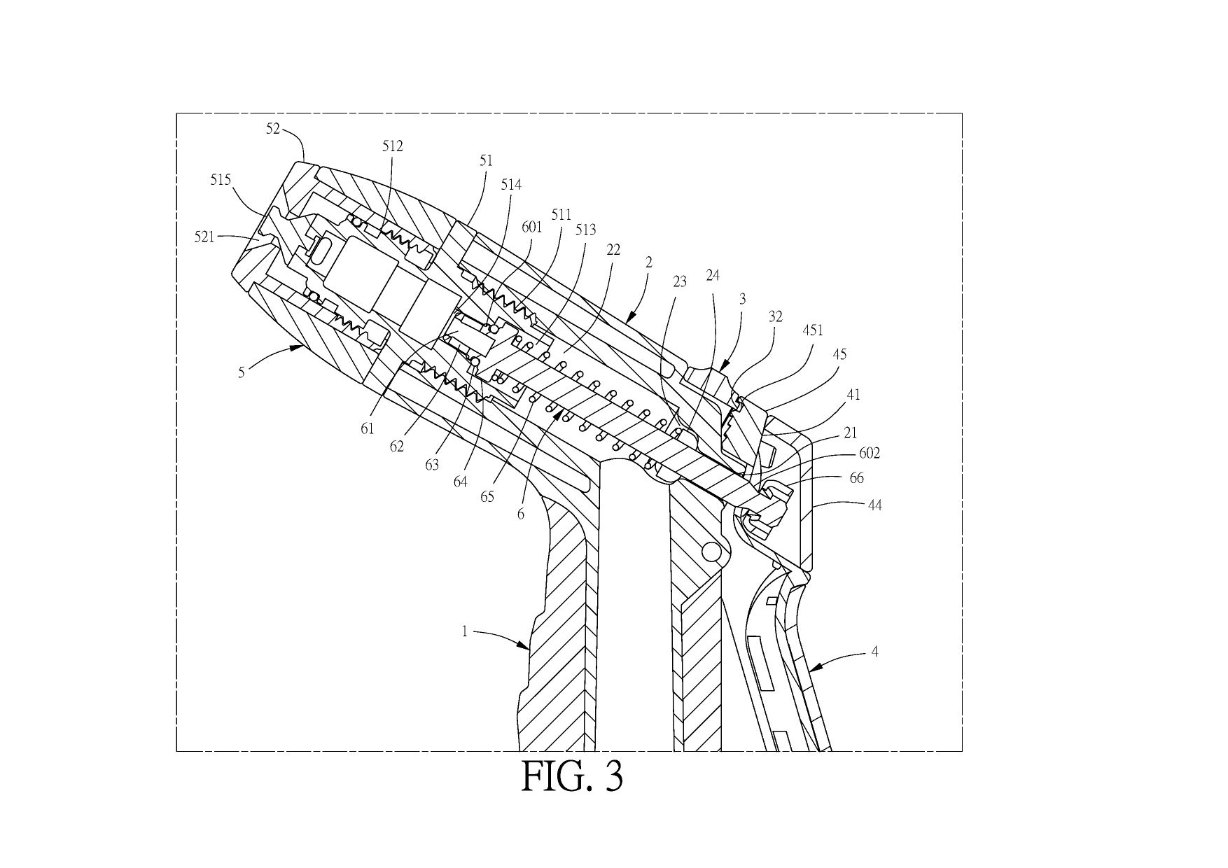

Please refer to FIG. 2 and FIG. 3 for further explanation. A water passage 11 is defined in the handle 1. The water passage 11 extends to the front end of the barrel 2. The rear end of the barrel 2 has a through hole 21 communicating with the water passage. A valve stem 6 is provided in the barrel 2. The valve stem 6 has a front end 601 inserted into the water inlet end 511 of the spray head 51 and a rear end 602 extending out of the through hole 21 and connected to the control lever 4. The valve stem 6 is moved by pivoting the control lever 4.

The front end 601 of the valve stem 6 has a cavity 61 extending in an axial direction thereof and facing the spray head 51 and at least one guide hole 62 radially running through the outside of the valve stem 6 and communicating with the cavity 61. The guide hole 62 is gradually enlarged in the axial direction of the valve stem 6 toward the front end 601 of the valve stem 6 to form a narrow end 621 and a wide end 622 close to the front end 601 of the valve stem 6. In this way, the guide hole 62 is gradually enlarged toward the front end 601 of the valve stem 6, not having the same width, which can reduce the distance of pulling the valve stem 6, and, in turn, reduce the pivoting range of the control lever 4 pressed by the user. In this embodiment, the front end 601 of the valve stem 6 is formed with two symmetrical guide holes 62, and the two guide holes 62 each have a triangular shape. In other feasible implementations, the guide hole 62 may be in the form of a flared horn or other flared shape, but not limited thereto.

Further, the water inlet end 511 of the spray head 51 has a large-diameter section 513 and a small-diameter section 514. The large-diameter section 513 and the small-diameter section 514 communicate with the water passage 22. The front end 601 of the valve stem 6 passes through the large-diameter section 513 and is inserted into the small-diameter section 514, so that the guide hole 62 is selectively covered by the small-diameter section 514. When the valve stem 6 is pulled and moved by the control lever 4, the area of the guide hole 62, covered by the small-diameter section 514, will be changed, thereby changing the area where the guide hole 62 communicates with the water passage 22. The valve stem 6 includes a blocking ring 63 behind the guide hole 62 for blocking the small-diameter section 514. A plurality of spaced guide blocks 64 are formed on the outer peripheral wall of the valve stem 6. The guide blocks 64 cooperate with the large-diameter section 513 for guiding the direction of movement of the valve stem 6, so that the valve stem 6 maintains axial linear displacement for smoother operation.

An annular groove 23 is formed at the junction of the water passage 22 and the through hole 21 in the barrel 2. A sealing ring 24 is fitted on the valve stem 6 and located in the annular groove 23 for sealing the through hole 21, so as to prevent water from leaking from the through hole 21 to the outside. A return spring 65 is fitted onto the valve stem 6. One end of the return spring 65 is against the guide blocks 64, and the other end of the return spring 65 is against the sealing ring 24, so that the valve stem 6 and the control lever 4 can be pushed back to their original positions by the elasticity of the return spring 65.

FIG. 2 and FIG. 3 illustrate the assembly of the valve stem 6 and the control lever 4. The control lever 4 has a coupling portion 41 facing the rear end of the barrel 2. The coupling portion 41 has a mounting hole 42 for insertion of the valve stem 6 and two lugs 43 extending outward and symmetrically disposed at two sides of the mounting hole 42. The rear end of the valve stem 6 passes through the mounting hole 42 and is connected to a restricting ring 66, so that the valve stem 6 and the control lever 4 are assembled securely. The two lugs 43 come into contact with the restricting ring 66 when the control lever 4 is pivoted. A sealing cover 44 is connected to the coupling portion 41 for sealing the rear end of the valve stem 6. The limiting space formed by the sealing cover 44 and the coupling portion 41 prevents the front end 601 from moving out of the small-diameter section 514 of the spray head 51 when the valve stem 6 is excessively pulled and moved by the control lever 4, thereby avoiding functional failure.

Referring to FIG. 3 through FIG. 6, the coupling portion 41 further has a protruding block 45 above the mounting hole 42. The protruding block 45 protrudes toward the rear end of the barrel 2. The protruding block 45 has a plurality of positioning grooves 451, 452, 453, 454 facing the barrel. In this embodiment, the protruding block 45 has four positioning grooves. The positioning buckle 3 corresponds in shape to the barrel 2 and has an arc shape. The positioning buckle 3 includes two symmetric support legs 31. The two support legs 31 are pivotally connected to two sides of the barrel 2. The positioning buckle 3 further includes a locking tooth 32 facing and protruding toward the positioning grooves 451, 452, 453, 454. When the control lever 4 is pressed by the user’s hand and pivoted toward the handle 1, the positioning buckle 3 is pushed by the finger of the same hand and pivoted toward the control lever 4 until the locking tooth 32 is locked in a corresponding one of the positioning grooves 451, 452, 453, 454, so as to secure the control lever 4.

In this embodiment, a diffusion ring 515 is provided at the water outlet end of the spray head 51. The regulating cap 52 has a flared mouth 52 corresponding to the diffusion ring 515. The distance between the diffusion ring 515 and the flared mouth 521 is adjustable by turning the regulating cap 52 for changing a spray pattern.

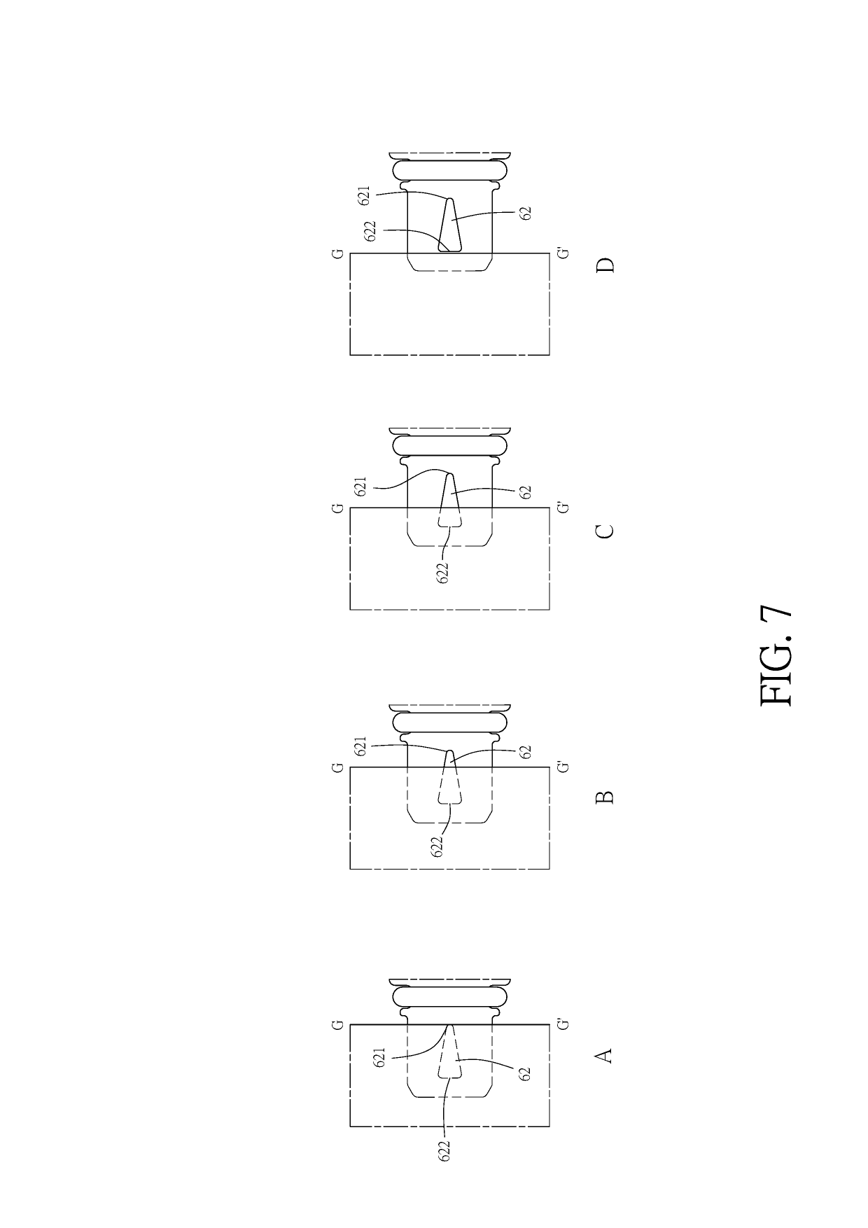

Referring to FIG. 3, the use of the water spray gun of the embodiment of the present invention is described below. Water flows from the bottom of the handle 1 through the water passage 11 to the barrel 2. First, when the control lever 4 is not pressed, the locking tooth 32 of the positioning buckle 3 is locked in the first positioning groove 451, and the valve stem 6 is pressed by the return spring 65 so that the control lever 4 is pivoted outward and positioned. At this time, as shown in FIG. 7A, the line G-G’ in the figure indicates the junction of the small-diameter section 514 and the large-diameter section 513. The guide hole 62 of the valve stem 6 is completely covered by the small-diameter section 514, and the blocking ring 63 at the front end closes the small-diameter section 514 of the water inlet end 511 of the spray head 51. Therefore, the water spray gun is in an OFF state and cannot spray water.

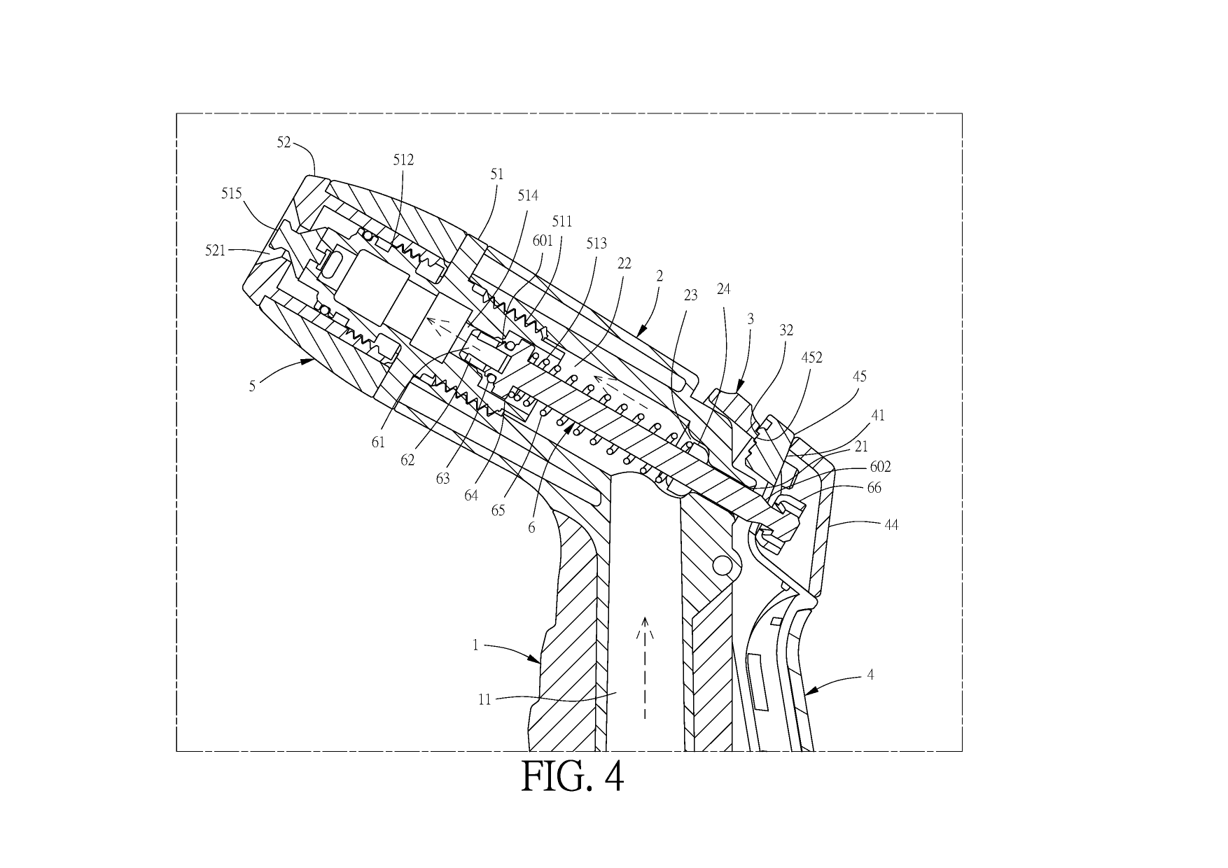

Referring to FIG. 4 through FIG. 7, when the control lever is pressed with appropriate force and then released, the locking tooth 32 of the positioning buckle 3 is selectively locked in the positioning groove 452, 453 or 454 of the control lever 4, so that the control lever 4 is positioned. At this time, the valve stem 6 is driven by the control lever 4 to move the blocking ring 63 away from the small-diameter section 514, so that the guide hole 62 is in communication with the water passage 22. The water in the barrel 2 flows through the gaps 641 between the guide blocks 64 to the cavity 61 via the guide hole 62 and then sprays out from the spray head 51. By controlling the stroke of pressing the control lever 4, the area of the guide hole 62 of valve stem 6, covered by the small-diameter section 514, can be changed, thereby changing the water flow rate.

As shown in FIG. 4 and FIG. 7B, when the control lever 4 is pressed with little force, the control lever 4 is pivoted to disengage the locking tooth 32 of the positioning buckle 3 from the first positioning groove 451. Then, the positioning buckle 3 is pivoted by the finger of the same hand, so that the locking tooth 32 is locked in the second positioning groove 452, and the valve stem 6 is slightly moved so the narrow end 621 of the guide hole 62 is in communication with the water passage 22 to supply a small amount of water flow.

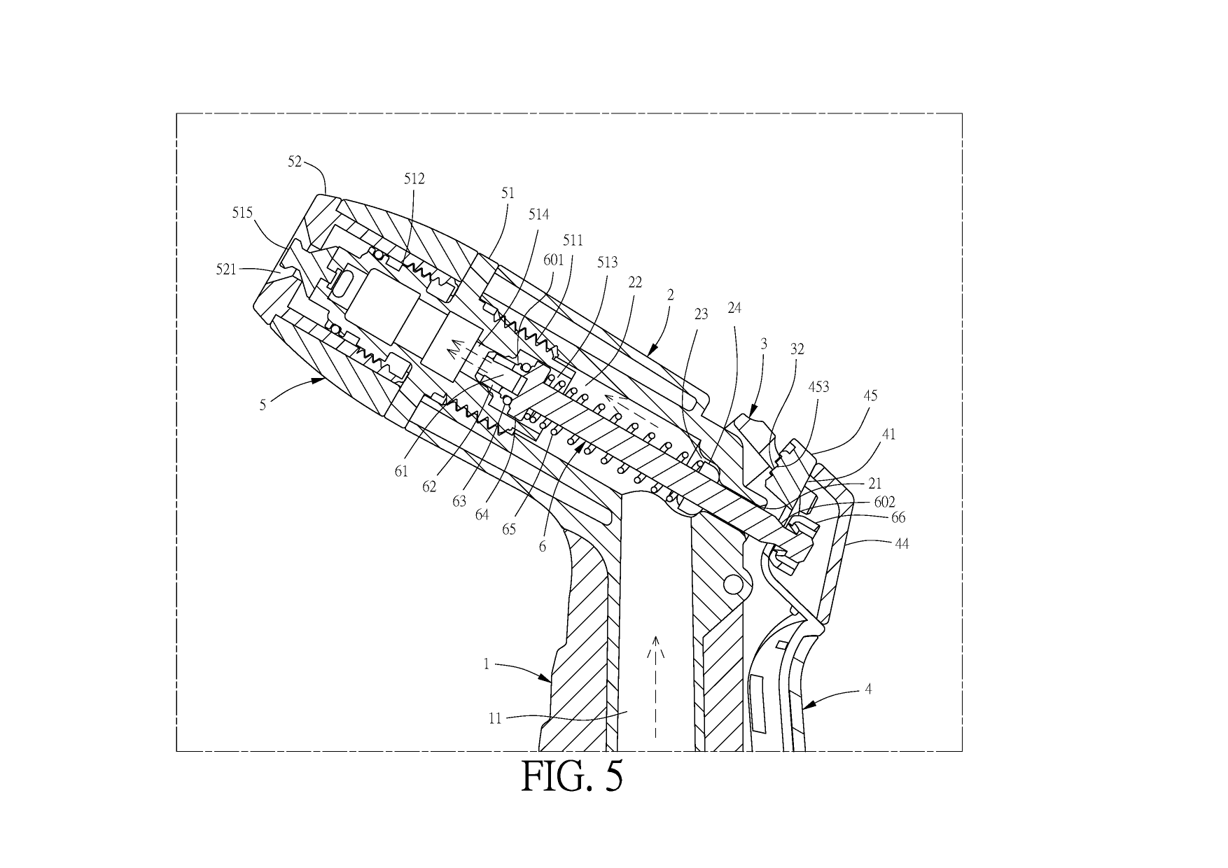

As shown in FIG. 5 and FIG. 7C, when the control lever 4 is pressed with medium force, the positioning buckle 3 is further pivoted by the finger of the same hand until the locking tooth 32 is locked in the third positioning groove 453. At this time, the valve stem 6 is moved moderately, so that the guide hole 62 is further moved away from the small-diameter section 514, that is, the narrow end 621 of the guide hole 62 is further away from the small-diameter section 514, and the area in communication with the water passage 22 is larger to supply a medium amount of water flow.

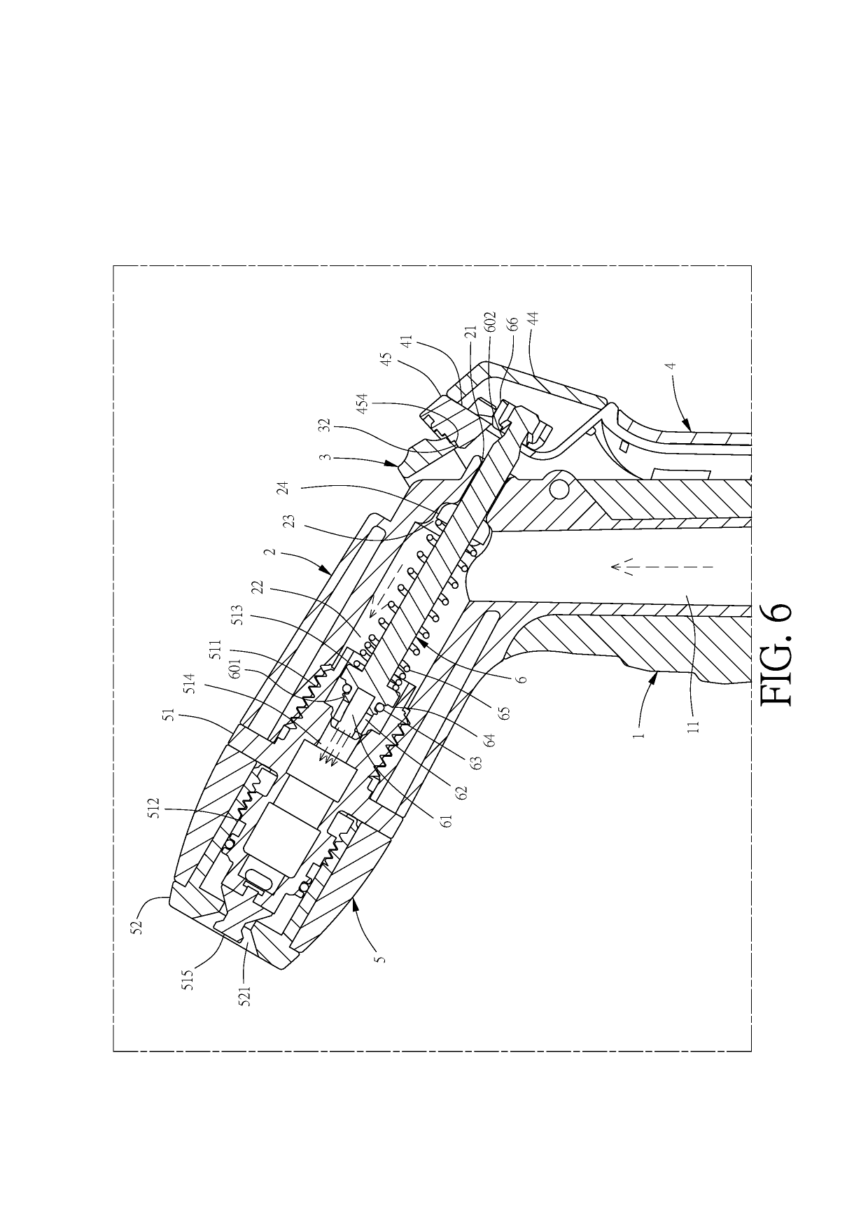

As shown in FIG. 6 and FIG. 7D, when the control lever 4 is pressed against the handle 1, the positioning buckle 3 is pivoted until the locking tooth 32 is locked in the fourth positioning groove 454, such that the guide hole 62 is fully moved away from the small-diameter section 514 so the wide end 622 is completely not covered by the small-diameter section 514 and the area in communication with the water passage 22 is maximized to supply the maximum water flow.

To turn off the water spray gun, the user just pushes the positioning buckle 3 with the finger of the same hand to separate it from the control lever 4 and then release the control lever 4. The return spring 65 pushes the valve stem 6 back to the original position with its elastic force, and the rear end of the valve stem 6 pulls the control lever 4 to pivot outward.

According to the above description, the water spray gun provided by the present invention can achieve the following effects:

Firstly, the water spray gun can be operated with one hand, making it easy to use. When in use, the user presses the control lever with one hand and moves the positioning buckle for the locking tooth to be locked in one of the positioning grooves with the finger of the same hand, such that the covered area of the guide hole can be changed, thereby changing the water flow rate. It is easy to use water spray gun.

Secondly, the stroke of pressing the control lever is shortened, making it easier to apply force and control. The guide hole is gradually enlarged toward the front end of the valve stem, not having the same width, which can reduce the distance of pulling the valve stem, thereby shortening the stroke of pressing the control lever, reducing the force required to apply, and making it easier to use.

Thirdly, the manufacturing difficulty is low, saving the production cost. The water passage of the barrel serves as the chamber for the valve stem to move, and the guide hole is cleverly designed at the front end of the valve stem to gradually expand outward in the axial direction of the valve stem. By moving the valve stem to change the position of the small-diameter section of the spray head to cover the guide hole, the water flow rate can be changed. This reduces the internal manufacturing procedures of the gun body, reducing the manufacturing difficulty greatly and saving production costs.

1. A water spray gun, comprising:
a gun body, having a handle and a barrel disposed on top of the handle, a water passage being defined in the handle, the water passage extending to a front end of the barrel, a rear end of the barrel having a through hole communicating with the water passage;
a positioning buckle, pivotally mounted on a top of the barrel;
a valve stem, disposed in the barrel, the valve stem having a rear end extending out of the through hole, a return spring being fitted onto the valve stem;
a control lever, pivotally mounted on a rear side of the handle, the rear end of the valve stem being coupled to the control lever, the valve stem being driven by the control lever to move in the barrel, the control lever having a plurality of positioning grooves corresponding to the positioning buckle, wherein when the positioning buckle is pivoted and engaged with one of the positioning grooves, the control lever is secured in a corresponding pivoted position;
a spray head unit, including a spray head having a flow channel therein and a regulating cap, the spray head being connected to the front end of the barrel, the valve stem having a front end inserted into a water inlet end of the spray head for opening and closing of the water passage, the regulating cap being screwed to a water outlet end of the spray head for regulating a spray pattern;
wherein the front end of the valve stem has a cavity extending in an axial direction thereof and facing the spray head and at least one guide hole radially running through the valve stem and communicating with the cavity, the guide hole is selectively covered by the water inlet end of the spray head, the guide hole is gradually enlarged in the axial direction of the valve stem toward the front end of the valve stem to form a narrow end and a wide end close to the front end of the valve stem, by pressing the control lever, the valve stem is driven to move toward the control lever, thereby changing a covered area of the guide hole for regulating a flow rate of water passing from the water passage to the cavity.

2. The water spray gun as claimed in claim 1, wherein the water inlet end of the spray head is inserted and screwed to the front end of the barrel, the water inlet end has a large-diameter section and a small-diameter section therein, the large-diameter section and the small-diameter section communicate with the water passage, and the front end of the valve stem passes through the large-diameter section and is inserted into the small-diameter section, so that the guide hole is selectively covered by the small-diameter section.

3. The water spray gun as claimed in claim 2, wherein the valve stem includes a blocking ring behind the guide hole for blocking the small-diameter section.

4. The water spray gun as claimed in claim 2, wherein a plurality of spaced guide blocks are formed on an outer peripheral wall of the valve stem, and the guide blocks cooperate with the large-diameter section for guiding movement of the valve stem.

5. The water spray gun as claimed in claim 4, wherein an annular groove is formed at a junction of the water passage and the through hole in the barrel, a sealing ring is fitted on the valve stem and located in the annular groove for sealing the through hole, one end of the return spring is against the sealing ring, and another end of the return spring is against the guide blocks.

6. The water spray gun as claimed in claim 1, wherein the control lever has a coupling portion facing the rear end of the barrel, the coupling portion has a mounting hole for insertion of the valve stem, the rear end of the valve stem passes through the mounting hole and is connected to a restricting ring so that the rear end is coupled to the control lever, the coupling portion further has two lugs extending outward and symmetrically disposed at two sides of the mounting hole, and the two lugs come into contact with the restricting ring when the control lever is pivoted.

7. The water spray gun as claimed in claim 6, wherein the coupling portion further has a protruding block above the mounting hole, the protruding block protrudes toward the rear end of the barrel, and the plurality of positioning grooves are formed on one side of the protruding block, facing the rear end of the barrel.

8. The water spray gun as claimed in claim 6, wherein a sealing cover is coupled to the coupling portion for sealing the rear end of the valve stem.

9. The water spray gun as claimed in claim 1, wherein the positioning buckle has an arc shape and includes two symmetric support legs, the two support legs are pivotally connected to two sides of the barrel, the positioning buckle further includes a locking tooth facing the positioning grooves, when the positioning buckle is pivoted until the locking tooth is locked in a corresponding one of the positioning grooves, the control lever is secured.
